(19) United States
(12) Patent Application Publication
(10) Pub. No.: US 2002/0179223 A1
(43) Pub. Date: Dec. 5, 2002

(54) Suspended-wafer chuck

(76) Inventors: Heather D. Boek, Corning, NY (US); Michael P. Carson, Corning, NY (US); Haibo Huang, Moorpark, CA (US); Pascale Laborde, Corning, NY (US); William P. Ryszytiwskyj, Corning, NY (US); Robert L. Young, Waxhaw, NC (US)

Correspondence Address: Nixon Peabody LLP, 8180 Greensboro Drive, McLean, VA, 22102, US

(21) Appl. No.: 09/872,123

(22) Filed: May 31, 2001

(51) Int. Cl. B44D 5/00

(52) U.S. Cl. 156/82; 427/450; 156/239

(57) ABSTRACT

A method for applying a flame for depositing a doped layer to a wafer and chuck particularly adapted for suspending the wafer over the flame. The chuck includes a frame having an opening defined by an inner wall for receiving a wafer and a ledge surrounding at least a portion of a lower end of the opening for retaining a wafer placed into an upper end of the opening, and a suspension assembly for suspending the frame over a dopant-depositing flame such that the ledge is disposed between the flame and peripheral portions of the wafer. The inner wall and the ledge may be formed from a material having substantially the same thermal conduction and expansion characteristics as the wafer. The suspension assembly may be rotatable with respect to a dopant-depositing flame. The frame may have a plurality of openings, each for receiving a wafer. The suspension assembly may include a suspension member, and a support post connecting the suspension member to the frame. The frame may also have an outer portion formed from a material having substantially different thermal conduction and expansion properties than the opening and ledge.

### BACKGROUND OF THE INVENTION

1. Field of the Invention

The present invention is directed to the field of chucks for use in wafer processing. In particular, the present invention is directed to a wafer chuck adapted to suspend a wafer over a flame for depositing a doped layer.

2. Technical Background

In the manufacturing and processing of planar devices that are used in optical systems, the formation of a thin film such as a doped layer onto a substrate of a wafer is required. Presently, a typical method of forming a doped glass layer on a wafer is through the flame hydrolysis deposition (FHD) process in which a precursor vapor is delivered to a burner in a lathe chamber. Dopant-containing soot particles that are formed in the flame are deposited onto the wafer supported in the lathe chamber. Most planar device manufacturers utilize a turn table design where the wafer is placed facing upward on a rotatable wafer chuck. The burner points downwardly toward the wafer chuck and deposits soot on the wafer supported thereon as the wafer chuck is rotated. After deposition and consolidation, the soot layer becomes a doped glass layer having a desirable thickness, refractive index, softening point, and thermal expansion coefficient which can then be used in the manufacturing of planar devices such as optical waveguides.

The prior art processes can be inefficient and difficult to implement for high volume manufacturing. For instance, in such applications, photolithography is typically conducted on the core layer to produce optical waveguides several microns in cross-section. Because there is no fiber drawing process such as in optical fiber manufacturing, any defect that lands on the planar layer cannot be removed or stretched out and collapsed. Thus, a small defect of several microns in size which may be negligible in a fiber cane can severely degrade the performance of a planar waveguide device if it lands in a critical area of the core layer. As a result, FHD processing for planar deposition has much more stringent quality control requirements and high rejection rates rendering the process inefficient.

To compound the inefficiencies of the prior art processes, flame hydrolysis deposition is intrinsically a “dirty” process in that contaminant particles of 0.05 to 0.2 microns are produced in the flame. The soot particles generally follow stream lines of lathe airflow and generally do not deviate due to their inertia and the thermophoretic forces which are generated by temperature gradients. The soot particles become deposited and accumulate on any surface in the lathe chamber to which the particles can adhere. Although the deposition rate is adjustable by controlling surface temperature and surface temperature gradient, there is no effective way to eliminate such build up on the lathe chamber and tools within the lathe chamber. The accumulated contaminant and debris can build up and fall on the wafer surface thereby contaminating the wafer. Thus, the lathe chamber as well as the tools therein need to be cleaned on a regular basis. Clearly, there exists a need for a wafer chuck that avoids the limitations of the prior art wafer chucks. In particular, there exists a need for a wafer chuck that will minimize contamination of the wafer supported by the chuck, as well as contaminant build up on the chuck itself. Furthermore, there also exists a need for a wafer chuck that will allow both uniform and efficient deposition of a doped layer on the wafers.

### SUMMARY OF THE INVENTION

In accordance with various preferred embodiments of the present invention, a chuck particularly adapted for suspending a wafer over a flame for depositing a doped layer includes a frame having an opening defined by an inner wall for receiving a wafer and a ledge surrounding at least a portion of a lower end of the opening for retaining a wafer placed into an upper end of the opening, and a suspension assembly for suspending the frame over a dopant-depositing flame such that the ledge is disposed between the flame and peripheral portions of the wafer.

In accordance with one preferred embodiment of the present invention, the inner wall and the ledge are formed from a material having substantially the same thermal conduction and expansion characteristics as the wafer. In accordance with another embodiment of the present invention, the chuck may also include a securing mechanism for securing the wafer in the frame. The suspension assembly may be rotatable with respect to a dopant-depositing flame. The wall and ledge are preferably formed from the same material. To facilitate volume processing, the frame may have a plurality of openings, each for receiving a wafer, each opening including a ledge at its lower end for retaining a wafer placed into its upper end.

In accordance with another embodiment of the present invention, the suspension assembly may include a suspension member, and a support post connecting the suspension member to the frame. The support post preferably spaces apart the suspension member and the frame to facilitate the insertion and removal of a wafer with respect to the frame opening. In addition, the suspension assembly may further include a stem connected to the suspension member. In other embodiments of the present invention, the frame may have an outer portion formed from a material having substantially different thermal conduction and expansion properties than the opening and ledge.

In accordance with still other embodiments of the present invention, the chuck is particularly adapted for suspending a wafer over a flame for depositing a doped layer in a flame hydrolysis deposition process, the chuck including a frame having an opening for receiving a wafer and a ledge surrounding at least a portion of a lower end of the opening for retaining a wafer placed into an upper end of the opening, an inner wall of the opening and ledge being formed of a material having substantially the same thermal conduction and expansion characteristics as the material forming the wafer, and a suspension assembly for suspending the frame over a dopant-depositing flame such that the ledge is disposed between the flame and peripheral portions of the wafer.

In accordance with other embodiments of the present invention, the ledge may include a plurality of detents mounted around the opening for capturing peripheral portions of a wafer retained within the frame. The ledge may further include a securing mechanism for securing the wafer in the frame. In this regard, one of the detents may be extendable and retractable into and out of a capturing position with respect to the wafer.

In still another embodiment, the frame may include an outer frame member and an insert mountable therein that includes the inner wall and ledge. Preferably, the material that forms the insert has substantially the same thermal conduction and expansion characteristics as the wafer. In accordance with the various embodiments, a bottom surface of the ledge may be flush with a bottom surface of the frame. The ledge may also be integrally connected to the frame opening and circumscribe the opening.

In yet another embodiment, the frame includes a plurality of openings for receiving a wafer, each of the openings including a ledge at its lower end for retaining a wafer placed into its upper end. The suspension assembly may include a suspension member, and a support postconnecting the suspension member to the frame. The support post may space apart the suspension member and the frame to facilitate the insertion and removal of a wafer with respect to the frame opening. Furthermore, the frame and suspension assembly may be rotatable with respect to the flame and the frame may be annular with a plurality of mounting holes around the circumference of the frame.

Moreover, in accordance with another aspect of the present invention, a method for applying a flame for depositing a doped layer to a wafer by means of a chuck includes a frame having an opening for receiving a wafer and a ledge at least partially circumscribing the opening for retaining a wafer placed within the opening, the method including the steps of suspending the frame over a source of a dopant-depositing flame such that the ledge is in a horizontal position, placing a wafer in the frame opening such that the wafer is retained and supported around opposing peripheral portions by the ledge, actuating the flame source, and applying the flame to an underside of the wafer. In one embodiment, the flame source generates a line-shaped flame, and the method may also include the step of rotating one of the flame source and the frame during the application step. In this regard, the flame source may remain stationary while the frame is rotated.

These features and advantages of the present invention will become more apparent from the following detailed description of the preferred embodiments of the present invention when viewed in conjunction with the accompanying drawings.

### BRIEF DESCRIPTION OF THE DRAWINGS

FIG. 1 is a perspective illustration of a suspended wafer chuck being used to deposit a doped layer on a wafer in accordance with one embodiment of the present invention.

FIG. 2 is another perspective illustration of a suspended wafer chuck of FIG. 1 together with a wafer wand which may be used to load and unload the wafer.

FIG. 3A is a partial perspective illustration of another embodiment of the suspended wafer chuck in accordance with the present invention.

FIG. 3B is a cross-sectional view of the suspended wafer chuck shown in FIG. 3A.

FIG. 4 is a perspective illustration of another embodiment of the frame in accordance with the present invention.

FIG. 5 is a perspective illustration of a suspended wafer chuck in accordance with another embodiment of the present invention with a plurality of openings.

### DETAILED DESCRIPTION OF THE INVENTION

As will be evident from the following discussion, the present invention provides an improved suspended wafer chuck that avoids the limitations of the prior art wafer chucks. In particular, the suspended wafer chuck in accordance with the present invention minimizes contamination of the wafer and contaminant buildup while allowing uniform and efficient deposition of a doped layer on wafers.

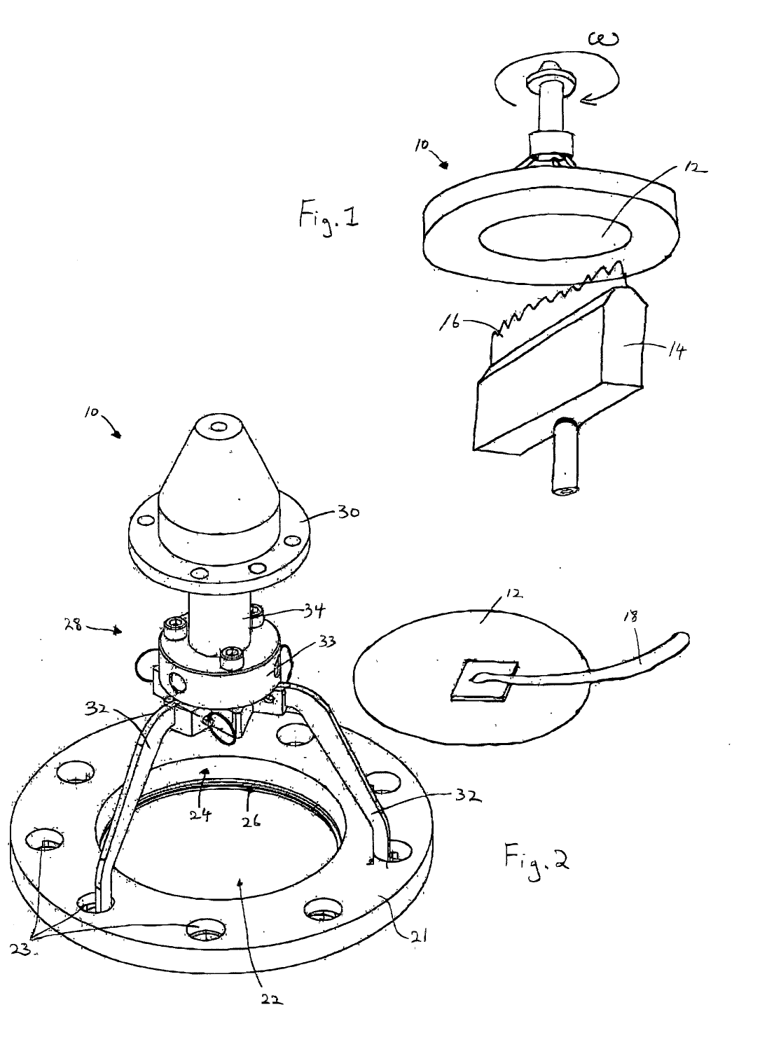

FIG. 1 shows a perspective illustration of the improved suspended wafer chuck 10 in accordance with one embodiment of the present invention being used to deposit a doped layer on a wafer 12 which may be made of silicon, a semiconductor material, or other materials suited for use as planar substrates in deposition processes such as those described herein. As can be seen, the wafer 12 is held by the chuck 10 over a burner 14 that generates a flame 16 for deposition of a doped layer on the wafer 12. In this regard, the chuck 10 and/or the burner 14 may be rotated at an angular velocity of co as shown to facilitate deposition of a uniform doped layer.

The general method and apparatus for deposition of a doped layer on a wafer was discussed in detail in U.S. patent application Ser. No. 08/988,170 filed on Dec. 10, 1997 and Ser. No. 09/444,954 filed on Nov. 22, 1999, both of which are incorporated herein by reference. In these applications, the burner produces a line of soot-generating flame and is mounted on an x-y-z table that allows the flame to sweep across the wafer surface in a controlled manner to deposit a soot layer which after consolidation, becomes a transparent glass layer having desirable thickness, refractive index, softening point, and thermal expansion coefficient that can then be used in the manufacturing of planar devices such as optical waveguides.

In these incorporated applications, the chuck was provided with vacuum to allow the wafer to be held against gravity. However, this vacuum chuck has been found to have several disadvantages that limit its use and prevent realization of the full potential of the suspended wafer chuck method. In particular, high defect levels have been found which result in low repeatability and low output capacity. Due to proximity of the wafer and loader surfaces, the wafer is prone to contamination. In addition, local thermal contact resistance between the wafer and the vacuum chuck's wafer seat can vary due to improper seating or due to particles between the wafer and the seat thereby leading to local variations in thermal moderation which leads to non-uniform deposition. Furthermore, as the vacuum chuck ages, contaminant soot particles get into the recessed area and negatively affect wafer-to-chuck seat contact that causes run-to-run variation in thickness, index and their uniformity. These problems are exacerbated in applications where the wafers have a reference flat corresponding to its crystallographic orientation that allows contaminant accumulation. Moreover, the suction used in the vacuum chuck of these incorporated patent applications sometimes induce wafer warpage in high temperature FHD process.

The chuck 10 in accordance with the embodiment of FIG. 1 (shown more clearly in FIG. 2) is particularly adapted for suspending the wafer 12 over the burner 14 and the flame 16 to allow deposition of a doped layer on the wafer 12 while eliminating or otherwise reducing the limitations of the prior art chucks as well as the vacuum chuck described above. In this regard, the illustrated embodiment of the chuck 10 as shown in FIG. 2 includes a frame 21 having an opening 22 defined by an inner wall 24 for receiving the wafer 12. As can also be seen in FIG. 2, the chuck 10 is also provided with a suspension assembly 28 for suspending the frame 21 over the burner 14 and flame 16. In accordance with the illustrated embodiment, the suspension assembly 28 includes a suspension member 30, and three support posts 32 (only two being shown) that connect the suspension member 30 to the frame 21 via mounting holes 23 which are provided on the circumference of the frame 21. The support posts 32 space apart the suspension member 30 and the frame 21 to facilitate the insertion and removal of the wafer 12 with respect to the frame opening 22. Additional mounting holes 23 are provide along the circumference of the frame 21 so that as one set becomes worn, the remaining mounting holes 23 may be used thereby providing maximum utility and reusability of the frame 21. In addition, the suspension assembly 28 shown also includes a hub 33 to which the support posts 32 are attached, and a stem 34 that connects the suspension member 30 to the support posts 32 via the hub 33.

As can be also seen in FIG. 2, the opening 22 of the frame 21 includes a ledge 26 that surrounds at least a portion of the lower end of the opening 22 so that the wafer 12 placed into the upper end of the opening 22 is retained and supported in the opening 22 by the ledge 26. More specifically, in the illustrated embodiment, the ledge 26 extends radially inwardly into the opening 22 so that the wafer 12 placed into the opening 22 is supported at its periphery by the ledge 26. As can be seen, the ledge 26 of this embodiment is integrally connected to the frame opening 22 and circumscribes the opening 22. In addition, the bottom surface of the ledge 26 is flush with a bottom surface of the frame 21 so as to minimize accumulation of contaminants. The wafer 12 may be loaded and unloaded from the opening 22 of the chuck 10 in any appropriate manner such as by a vacuum wand 18 shown in FIG. 2 which temporarily holds the wafer 12 by applying a vacuum to the wafer 12. Of course, a different mechanism may be used to load and unload the wafer 12 from the opening 22 as well. As can be readily appreciated, the wafer 12 is inserted into the upper end of the frame opening 22 by initially inserting the wafer 12 between two of the support post 32 and then, lowering it within the opening 22. The wafer 12 is then released within the frame opening 22 by a loading/unloading device such as the vacuum wand 18 shown so that the wafer 12 is supported along its periphery by the ledge 26 that surrounds at least a portion of the lower end of the opening 22.

Thus, in the manner described above, the wafer 12 is supported by the ledge 26 as shown in FIG. 1 so that the ledge 26 is disposed between the flame 16 and the peripheral portions of the wafer 12 when the doped layer is being deposited on the wafer 12. This can be advantageous because the surface of the ledge 26 which supports the wafer 12 (i.e. the seating surface of the ledge 26) is never directly exposed to the flame 16 during the doped layer deposition process. Thus, contamination does not accumulate on the surface of the ledge 26 which supports the wafer 12 thereby ensuring consistently level support of the wafer 12 within the opening 22 of the frame 21. In addition, contamination from chucking is minimized because the wafer is dropped into the frame 21 of the chuck 10 from a side of the chuck 10 where there is no contaminant accumulation.

In accordance with one embodiment of the present invention, the inner wall 24 and the ledge 26 of the opening 22 in the frame 21 are preferably formed from a material having substantially similar thermal conduction and expansion characteristics as the wafer 12 itself. In this manner, the expansion and contraction of the inner wall 24 and the ledge 26 relative to the wafer 12 is minimized to thereby minimize movement and/or stresses on the wafer 12. In addition, the frame 21 or at least a portion thereof is made of a material that resists spalling or flaking of contaminant particles such as soot during the doped layer deposition process. In this regard, quartz has been found to be a suitable material for the frame 21 and correspondingly the inner wall 24 and the ledge 26 may be both made from quartz. As previously described relative to FIG. 1, the suspension assembly 28 of the chuck 10 is rotatable with respect to the flame 16 at an angular velocity of co to thereby facilitate deposition of a uniform doped layer.

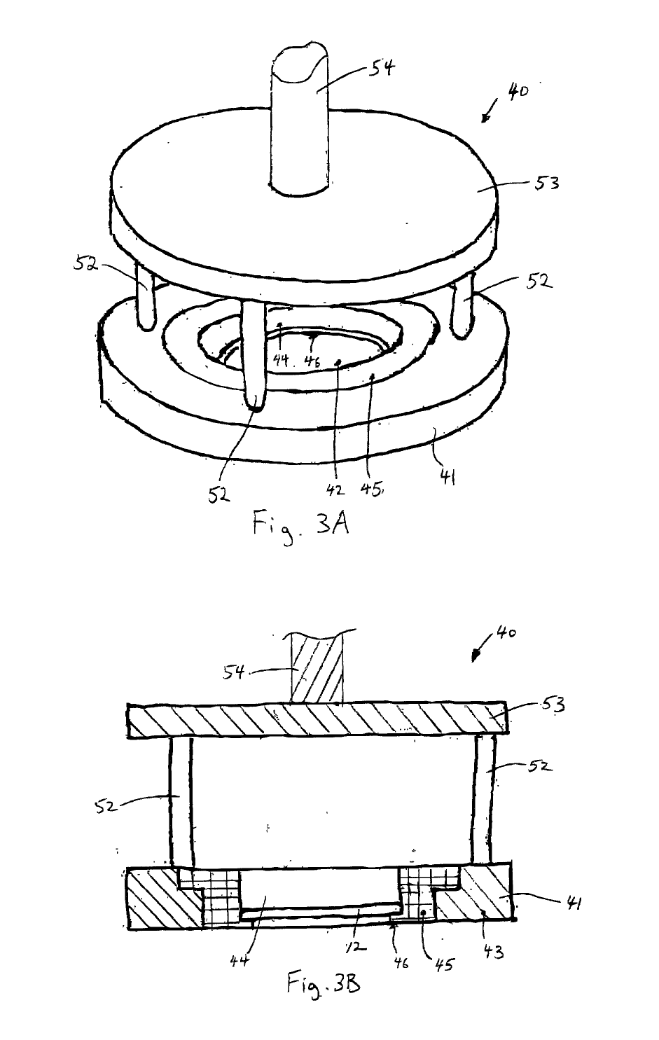

FIGS. 3A and 3B show another embodiment of the improved suspended wafer chuck 40 in accordance with the present invention, FIG. 3B showing a cross-sectional view. As can be seen in these figures, the chuck 40 in accordance with the illustrated embodiment is somewhat configured differently than the embodiment of FIGS. 1 and 2 in that it is provided with a hub 53 that is similar in size to the frame 41. As can also be seen, the frame 41 is connected to the hub 53 by three support posts 52, the hub 53 being connected to the stem 54 that in turn, connects to a suspension member (not shown). In a similar manner to the embodiment of FIG. 2, the support posts 52 space apart the suspension member (not shown) and the frame 41 to facilitate the insertion and removal of the wafer 12 with respect to the frame opening 42. Thus, as previously described, the wafer 12 is inserted into the upper end of the frame opening 42 by initially inserting the wafer 12 between two of the support post 52 and then, lowering it within the opening 42. The wafer 12 is then released within the frame opening 42 so that the wafer 12 is supported along its periphery by the ledge 46 that surrounds at least a portion of the lower end of the opening 42.

As can be seen especially clearly in FIG. 3B, the frame 41 of this embodiment includes an outer frame member 43 and an insert 45 mountable therein. The insert 45 includes the opening 42 which has the inner wall 44 and the ledge 46. As can be seen in the illustrated embodiment, the bottom surface of the ledge 46 is flush with a bottom surface of the frame 41 so as to minimize accumulation of contaminants. In addition, as with the embodiment of FIG. 2, the ledge 46 circumscribes the opening 42. By providing a separate insert, various advantages can be attained. In particular, the material that forms the insert 45 may have substantially the same thermal conduction and expansion characteristics as the wafer 12 supported therein to minimize movement and/or stresses on the wafer 12. In this regard, as previously described, the insert 45 with the inner wall 44 and the ledge 46 may be made from quartz while the outer frame member 43 is made from a different material which is more economical than the material of the insert 45. In addition, if the ledge 46 of the insert 45 is damaged in any way, it can be readily replaced without having to replace the whole chuck 40. In such an embodiment, the frame 41 may have an outer portion 43 that is formed from a material having substantially different thermal conduction and expansion properties than the opening 42 and the ledge 46 to minimize cost. Of course, it should also be noted that the opening 22 of chuck 10 described previously may also be provided on an insert in the manner described relative to the present embodiment instead of directly on the frame 21 itself.

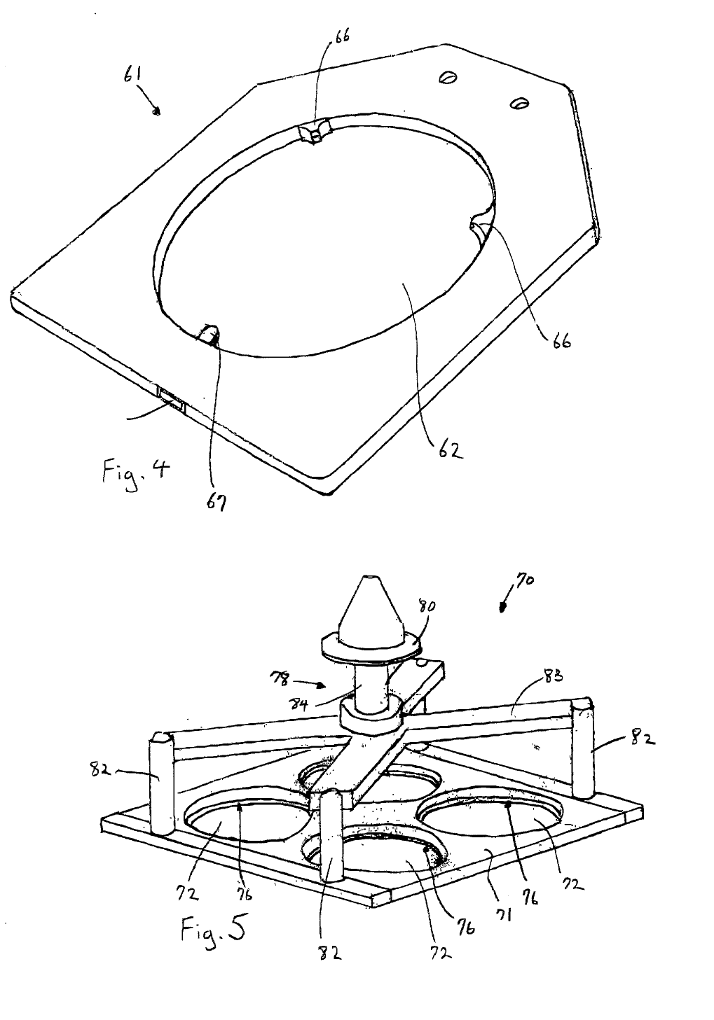

FIG. 4 is a perspective illustration of a frame 61 in accordance with another embodiment of the present invention. As can be seen, the frame 61 is different from the frames described in the previous embodiments in that the ledge is actually formed by a plurality of detents 66 mounted around the opening 62 for capturing the edge portions of a wafer (not shown). In this regard, the term ledge should be understood to encompass such detents. In the illustrated embodiment, the ledge may further include a securing mechanism in the form of an extendable/retractable detent 67 for securing the wafer in the frame 61 along its peripheral edge. Of course, in an alternative embodiment, the ledge may have detents that merely support the wafer along the peripheral edge surface in a similar manner to the embodiments described previously. Other details of the chuck which may utilize the illustrated frame 61 is omitted for clarity purposes but should be evident in view of the illustrations of FIGS. 1 to 3B which have been described in detail above.

FIG. 5 illustrates yet another embodiment of a wafer suspended chuck 70 in accordance with the present invention. As shown in FIG. 5, the frame 71 of the chuck 70 is provided with a plurality of openings 72, each opening being adapted to receive a wafer (not shown) so as to facilitate efficient depositing of a doped layer on wafers by suspending and allowing processing of a plurality of wafers at the same time. In this regard, each opening 72 includes a ledge 76 at its lower end for retaining a wafer placed into its upper end. In the manner generally described previously, the chuck 70 is adapted to suspend a plurality of wafers over a burner and flame like that shown in FIG. 1 to allow deposition of a doped layer. As can also be seen in FIG. 5, the chuck 70 is also provided with the suspension assembly 78 for suspending the frame 71 over the burner and flame. In the illustrated embodiment, the suspension assembly 78 includes a suspension member 80, four support posts 82, a hub 83, and a stem 84 that interconnect the suspension member 80 to the frame 71 and allow the chuck 70 to be rotated with respect to the flame to facilitate deposition of a uniform doped layer.

Also in the previously described manner, the support posts 82 space apart the suspension member 80 and the frame 71 to facilitate the insertion and removal of the wafer with respect to the frame openings 72. Wafers are inserted into the upper end of the frame openings 72 so that they are supported along their periphery by the ledges 76 that surround at least a portion of the openings 72. Again, the frame 71 may be formed from a material such as quartz that has substantially similar thermal conduction and expansion characteristics as the wafer itself. Of course, the openings 72 may also be provided on an insert in the manner described relative to FIGS. 3A and 3B.

Thus, the above described chucks can be used to apply a flame for depositing a doped layer to a wafer as generally shown in FIG. 1. As described relative to the various illustrated embodiments, the chuck includes a frame having an opening for receiving a wafer and a ledge at least partially circumscribing the opening for retaining a wafer placed within the opening. The wafer is placed in the frame opening such that the wafer is retained and supported around opposing peripheral portions by the ledge. The flame source can then be actuated and the flame applied to an underside of the wafer to deposit a doped layer to the wafer in the manner generally described in U.S. patent application Ser. No. 08/988,170 and Ser. No. 09/444,954 which were incorporated by reference previously. Preferably, the burner 14 of FIG. 1 generates a line-shaped flame 16, and the frame with the wafer supported therein is rotated during the application step to provide uniform and efficient deposition of a doped layer on the wafer.

In utilizing the suspended wafer chuck in accordance with the present invention, doped layer uniformity can be optimized by changing burner standoff, burner motion speed, chuck rotation speed, precursor delivery rate and a host of other parameters. Wafers having superior uniformity were attained as compared to that of wafers which were processed using prior art chucks or the vacuum chuck described in the incorporated references. In addition, such uniformity has been achieved on large quantities of wafers by optimizing these deposition parameters.

More specifically, in using the wafer suspended chuck shown in FIGS. 1 and 2, wafer uniformity exceeding the <0.02% delta and <0.2 μm thickness targets was achieved with approximately 50% yield on 127 sample run wafers, and uniformity of <0.01% and <0.1 μm was achieved with 10% yield, this uniformity being comparable to that of world leader Ionas® cores which were made by a PECVD process. When new burner motion algorithms were implemented for further optimization, uniformity exceeding the <0.02% delta and <0.2 μm thickness targets was achieved with approximately 85% yield on 126 consecutive wafers and uniformity of <0.01% and <0.1 μm was achieved with 23% yield. Most remarkably, the within-wafer index uniformity of these 126 wafers averages at 0.007% which approaches the measurement resolution of the Metricon® instrument used to measure such uniformity. In addition, the wafer-to-wafer variations of thickness and index were reduced by more than a factor of two. Of course, whereas these validation experiments were conducted using the embodiment of the present invention as shown in FIGS. 1 and 2, similar performance in wafer uniformity, total yield, thickness and within-wafer index should be possible by using the other embodiments of the present invention shown in FIGS. 3A to 5 as well.

Thus, in view of the above, the drop-in wafer suspended chuck in accordance with the present invention has numerous advantages over other chucks. As described in detail above, the wafer suspended chuck in accordance with the present invention readily extends to multiple wafer chucking as shown in FIG. 5 to maximize the “upside down” doped layer deposition process described in the incorporated references. Contamination from chucking is reduced by dropping wafer into the chuck from a side of the chuck where there is no contamination. Because the portion of the frame that supports the wafer is made of a material having substantially the same thermal expansion characteristics, the wafer is not stressed by the chuck thereby eliminating the need for extended preheat time. In this regard, quartz may be used which further minimizes spalling or flaking of contaminant particles during thermal cycling and minimizes adhesion of contaminants on the chuck. In addition, by eliminating localized thermal variations during deposition, both within-wafer and wafer-to-wafer repeatability is maximized. Furthermore, the chucks in accordance with the present invention are readily adaptable to silicon wafers having reference flats. Moreover, wafer breakage due to improper seating is reduced by using the chucks of the present invention which provide a drop-in support of the wafer. Lastly, the required maintenance of the chuck of the present invention is significantly reduced over a vacuum chuck.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A chuck particularly adapted for suspending a wafer over flame for forming a doped layer, comprising:
a frame having an opening defined by an inner wall for receiving a wafer and a ledge surrounding at least a portion of a lower end of said opening for retaining a wafer placed into an upper end of said opening, and
a suspension assembly for suspending said frame over a dopant-depositing flame such that said ledge is disposed between said flame and peripheral portions of said wafer.

2. The chuck defined in claim 1, wherein said inner wall and said ledge are formed from a material having substantially the same thermal conduction and expansion characteristics as said wafer.

3. The chuck defined in claim 1, further comprising a securing mechanism for securing said wafer in said frame.

4. The chuck defined in claim 1, wherein said suspension assembly is rotatable with respect to a dopant-depositing flame.

5. The chuck defined in claim 2, wherein said wall and ledge are formed from the same material.

6. The chuck defined in claim 1, wherein said frame has a plurality of openings for receiving a wafer, each of which includes a ledge at its lower end for retaining a wafer placed into its upper end.

7. The chuck defined in claim 1, wherein said suspension assembly includes a suspension member, and a support post connecting said suspension member to said frame.

8. The chuck defined in claim 7, wherein said support posts space apart said suspension member and said frame to facilitate the insertion and removal of a wafer with respect to said frame opening.

9. The chuck defined in claim 7, wherein said suspension assembly further includes a stem connected to said suspension member.

10. The chuck defined in claim 1, wherein said frame has an outer portion formed from a material having substantially different thermal conduction and expansion properties than said opening and ledge.

11. A chuck particularly adapted for suspending a wafer over a flame for forming a doped layer in a flame hydrolysis deposition process, comprising:
a frame having an opening for receiving a wafer and a ledge surrounding at least a portion of a lower end of said opening for retaining a wafer placed into an upper end of said opening, an inner wall of the opening and ledge being formed of a material having substantially the same thermal conduction and expansion characteristics as the material forming the wafer, and
a suspension assembly for suspending said frame over a dopant-depositing flame such that said ledge is disposed between said flame and peripheral portions of said wafer.

12. The chuck defined in claim 11, wherein said ledge includes a plurality of detents mounted around said opening for capturing peripheral portions of a wafer retained within said frame.

13. The chuck defined in claim 12, wherein said ledge further comprises a securing mechanism for securing said wafer in said frame.

14. The chuck defined in claim 13, wherein one of said detents is extendable and retractable into and out of a capturing position with respect to said wafer.

15. The chuck defined in claim 11, wherein said frame includes an outer frame member and an insert mountable therein that includes said inner wall and ledge.

16. The chuck defined in claim 15, wherein said insert is formed of said material having substantially the same thermal conduction and expansion characteristics as said wafer.

17. The chuck defined in claim 11, wherein a bottom surface of said ledge is flush with a bottom surface of said frame.

18. The chuck defined in claim 11, wherein said ledge is integrally connected to said frame opening and circumscribes said opening.

19. The chuck defined in claim 11, wherein said frame has a plurality of openings for receiving a wafer, each of which includes a ledge at its lower end for retaining a wafer placed into its upper end.

20. The chuck defined in claim 19, wherein said suspension assembly includes a suspension member, and a support post connecting said suspension member to said frame.

21. The chuck defined in claim 20, wherein said support posts space apart said suspension member and said frame to facilitate the insertion and removal of a wafer with respect to said frame opening.

22. The chuck defined in claim 11, wherein said frame and suspension assembly are rotatable with respect to said flame.

23. The chuck defined in claim 22, wherein said frame is annular and includes said plurality of mounting holes around the circumference of said frame.

24. A method for applying a flame to a wafer to form a doped layer by means of a chuck including a frame having an opening for receiving a wafer, and a ledge at least partially circumscribing said opening for retaining a wafer placed within said opening, comprising the steps of:
suspending said frame over a source of a dopant-depositing flame such that said ledge is in a horizontal position;
placing a wafer in said frame opening such that said wafer is retained and supported around opposing peripheral portions by said ledge;
actuating said flame source, and
applying said flame to an underside of said wafer.

25. The method defined in claim 24, wherein said flame source generates a line-shaped flame, and further comprising the step of rotating one of the flame source and the frame during said application step.

26. The method defined in claim 25, wherein said flame source remains stationary while said frame is rotated.
